(19) United States
(12) Patent Application Publication
(10) Pub. No.: US 2010/0306043 A1
(43) Pub. Date: Dec. 2, 2010

(54) Measuring Impact Of Online Advertising Campaigns

(76) Inventors: Robert Taaffe Lindsay, San Francisco, CA (US); Thomas Carriero, Menlo Park, CA (US); Yun-Fang Juan, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 12/472,318

(22) Filed: May 26, 2009

(51) Int. Cl. G06Q 30/00

(52) U.S. Cl. 705/14.41; 705/14.44

(57) ABSTRACT

Methods and systems allow measurement of effectiveness of advertising campaigns based on online advertisements targeted towards specific sets of members. A set of members is allowed to see an advertisement whereas another set of members is withheld from seeing the advertisement under conditions similar to the first set. Test sets obtained from the two sets of members are polled with questions evaluating effectiveness of advertisement. The poll questions evaluate effectiveness based on factors including brand awareness, purchase intent, or brand favorability. Statistical analysis is performed to quantitatively measure the effectiveness of the advertisement by measuring the improvement in above factors as a result of showing the advertisement.

### FIELD OF THE INVENTION

This invention relates generally to systems and methods for evaluating the efficacy of advertising campaigns, and in particular to evaluating the impact of online advertising campaigns directed towards members of a social networking service.

### BACKGROUND

Many businesses dedicate significant resources to advertising their products through advertising campaigns. A typical advertising campaign includes one or more advertising messages communicated to potential customers to meet an advertising objective. One objective of an advertising campaign can be to increase awareness of the product being advertised; another objective can be to generate a favorable opinion of a product to convince people to buy the advertised product. Advertisers use various forms of media to communicate advertising messages including television, newspapers, radio, cinema, television, newspapers, billboards, internet and the like. Use of the internet is becoming increasingly popular among advertisers compared to more conventional means of advertisement.

Advertisers typically are interested in measuring the effectiveness of their advertisements (also referred to as “ads”) in meeting their objectives. Accurate measurement of the effectiveness of an advertising campaign allows an advertiser to understand the return on investments they are receiving from their advertising, and allows the advertiser to adjust its marketing strategy if necessary. However, accurate measurement of the effectiveness of an advertising campaign requires a controlled environment that is difficult to achieve in practice. This is because attempts to develop a control group will suffer from selection bias. For example, an advertiser might roll out an advertising campaign on local television shows in one city, not run ads in another city, and measure the difference in awareness by phone surveys in the two cities. However, there might be baseline differences between the populations of those cities independent of ad exposure that influence the outcome. For example, due to demographic differences between populations of cities, people in one city may be biased towards a product compared to people of the other city.

To attempt to get around this, advertisers typically use focus groups or marketing tests with restrictive settings to establish well-defined control and test populations. These groups can be constructed to balance the two groups on variables such as age, gender, and socio-economic status. This research has limitations, however, since the highly controlled nature of these environments bears little resemblance to a real-world setting where people would be normally exposed to these campaigns.

The effectiveness of conventional forms of advertising can be measured to a certain extent by studying the overall effect of the advertising campaign (e.g. by measuring any increase in sales at the conclusion of the campaign). The same methods can be used to measure the effectiveness of online advertising. Additional metrics specific to online advertising can also be used to supplement traditional methods of measuring effectiveness. For example, for an online advertising campaign one can assess the number of impressions of an advertisement that were shown, the number of individuals who clicked on an advertisement, an/or the number of individuals that visited the advertiser's website during the course of the advertising campaign, etc. Both traditional and online specific methods for measuring the effectiveness of advertising campaigns have limitation however. Simply measuring sales before and after a traditional or online advertising campaign will not provide a measurement of the effectiveness with a high degree of reliability, because this method cannot account for extrinsic factors that may have impacted sales. While providing more insight into the effectiveness of online advertising, existing online-specific metrics are still lacking because they provide only an indication of the effectiveness of a campaign. Actual effectiveness can only be inferred. For example, an online ad that is highly effective in conveying a message may, nonetheless, register the same number of clicks as an ineffective ad. Therefore, existing traditional and online-specific methods of measuring the effectiveness of online advertisements can still be improved upon in terms of determining actual effectiveness.

### SUMMARY

Embodiments of the invention provide advertisers with an objective basis for measuring the effectiveness of online advertising campaigns and techniques within an online system. The embodiments allow advertisements to be selectively targeted and/or provided to specific sets of members of the system, withheld from other sets of members, and customized for additional sets of members. Feedback can then be solicited from the sets to be compared, contrasted and analyzed for determining a measure of effectiveness of a particular campaign, advertising method or technique. A member accesses the online system, and the system selects an advertisement for potential presentation to the member. In one embodiment, these advertisements may be associated with the member based on demographic criteria, information about the member in the member's profile, or the member's behavioral activities within or outside the online system.

Advertising campaigns are typically made up of one or more advertisements about a particular product or service. Users of an online system are placed into sets of members. Membership in a set determines what advertisements the member sees from a particular advertising campaign, if any. If the member belongs to a predetermined set of members designated as the sample set, the member is presented with advertisements from the advertising campaign. On the other hand, if the member belongs to a different predetermined set of members designated as the control set, advertisements are withheld and not presented to the member. This provides at least two sets of members, the sample set that is presented with advertisements from a campaign, and the control set from which advertisements are withheld. Thus, the two sets of members can be compared to analyze if the advertisements had a favorable impact, since the only distinguishing factor between the two sets of members is the presentation of advertisements from the campaign. In other embodiments, one or more additional sets of members may be established and presented with some variation of the standard advertising campaign to provide further information to advertisers about what aspects of a particular advertising campaign are most effective. Sample subsets of members are selected from each of the above sets and evaluated to measure the effectiveness of the advertising campaign, or certain aspects thereof.

In one embodiment, members are assigned to a particular set based upon their member ID. In one embodiment, this assignment comprises computing a hash value based a member ID associated with the member, and assigning a member to one of the sets based on the hash value. The hash value output from the hash function can be divided into ranges where each range corresponds to a subset of members, thereby providing the capability for multiple different sample sets, control sets and additional sets of members. The various sets of members can be used for measuring the effectiveness of different advertisements or combinations of advertisements provided to various sets of members.

Once the two or more groups of members have been selectively shown the advertisements, the effectiveness of the advertisements can be evaluated. In one embodiment, the effectiveness of the advertisement is evaluated by sending one or more questions to one or more members belonging to the sample set inquiring about the effectiveness of the advertisement. The responses provided are used for evaluating the effectiveness of the advertisement. The questions presented to the member of a set may inquire about the member's awareness of the advertiser or a product advertised, the member's impression of the advertiser or product advertised, or any other information the advertiser believes to be relevant to determining the effectiveness of a particular advertising campaign. Analysis is performed on member responses to determine the effectiveness of the advertising campaign, or certain aspects thereof.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is the architecture of the system that allows measurement of impact of advertisements using information from members of a website in accordance with an embodiment of the invention.

FIG. 2 is an illustration of an online advertisement presented to a member.

FIG. 3 is an illustration of a graphical user interface presenting a poll question to a member in accordance with an embodiment of the invention.

FIG. 4 is a flowchart of the overall process in accordance with an embodiment of the invention for determining whether an advertisement is shown to a member or withheld from the member in accordance with an embodiment of the invention.

FIG. 5 illustrates the use of a hash function to determine if a member ID belongs to a particular set of member IDs.

FIG. 6 is a flowchart of the process for conducting polls for sample sets of members and analyzing the poll results to measure effectiveness of an advertising campaign in accordance with an embodiment of the invention.

FIG. 7 illustrates the results of an analysis of the measure of effectiveness for an advertising campaign.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Measuring Impact of Advertising Campaigns

An online advertising campaign in an online system presents advertisements to a set of members who are selected to receive the advertisement. In one embodiment a member of an online system registers with the online system; this allows the system to reliably identify the member on subsequent visits. For example, the member may register for an account with a user name and password. In another embodiment, the member does not have to register with the system, but the system employs other means for reliably identifying the member subsequently, such as analyzing the member's access patterns to the system.

In both embodiments, the online system stores information related to the member as part of a member profile, which information about the member that can be used to selectively target the member for various advertising campaigns. The profile can store information as the member's demographics, including gender, age, geographical region, stated interests or preferences, professional, personal, or educational affiliations, or income. The profile can also store historical information associated with activities of the member within and outside the online system. The profile can be explicit, such as a form where the member can edit and modify the information in the profile, or implicit, such as information accumulated by the online system about the member's activities. These activities include the member's access patterns to the online system, such as which pages, features, tools, services and the like. The types of activities that are tracked are dependent on the system of online system.

The online system may also generate a member ID and have mechanisms to identify the member's information using attributes identifying the member, for example, first and last name and date of birth.

An example of an online system is a social networking system that stores member profile information including demographic information of members and/or information about the members online activities. Another example of an online system is an e-commerce system that stores a user's account information and usage history (e.g., products purchased, products reviewed, products looked at, etc.). Another example of an online system is a forum or blog site where a user has a profile and history of comments and postings. In other embodiments, the online system maintains for each member an access or usage profile, but members do not create explicit accounts. For example, an online system such as news website may store access information for each member, but not require the members to create accounts.

In some embodiments, an advertisement may be targeted to a set of members based on attributes of the member. These attributes can be descriptive or behavioral. For example, descriptive attributes include attributes that describe demographic information related to members or any other information about the members contained in their profiles. Behavioral attributes include members' behavioral activities within or outside the online system. Measurement of the effectiveness of an advertising campaign is desirable to advertisers who wish to evaluate an advertising campaign and improve its effectiveness. Methods and systems for evaluating the effectiveness of an advertising campaign compare a sample set of members that are presented with the advertisements from the campaign with a control set of members from which advertisements from the campaign are withheld. All other factors of the two sets of members are kept constant to each other to mitigate impact of anything other than the advertisements(s). Hence, a precise control is exercised to ensure who is able to see the advertisement(s) and who is withheld from seeing the advertisement(s). In other embodiments, additional sets of members may be established and presented with some variation of the standard advertising campaign. For example, an additional set of members may receive advertisements in a different order, for different durations, containing information associated with, or generated by, other members of the system related to the advertising campaign, or only a subset of advertisements from the campaign, etc. Analysis of these additional sets of members can provide further information to advertisers about what techniques or aspects of a particular advertising campaign are most effective.

The comparison of the two or more sets of members is performed by presenting the members with questions aimed at measuring the effectiveness of the advertising campaign. For example, if the advertisement presents a specific fact related to a product, a set of poll questions can inquire about the member's awareness of the specific fact. This allows evaluation of the advertisement to measure how effectively the advertisement is increasing product awareness. Alternatively, the questions can inquire about other factors that might demonstrate the effectiveness of the advertising campaign, for example, purchase intent of the members or brand favorability. Accordingly, one or more measures of effectiveness can determine if the advertising campaign, or certain techniques or aspect thereof, is increasing the public's purchase intent or overall brand favorability.

The ability to quantify a measure of effectiveness of an advertisement or advertising campaign allows advertisers to improve their advertising campaigns by deciding which advertisements to promote and which to alter or eliminate. Using a measure of effectiveness, the advertiser can identify the most and least effective advertisements, as well as effective combinations of different elements of an advertising campaign. Also, various other factors can be analyzed for improvement, including order in which advertisements belonging to an ad campaign are presented to the member or the length of time that an advertisement should be shown for optimal effectiveness. The impact of showing a single advertisement can be compared with showing various combinations of advertisements to the same set of members. For example, if an advertising campaign has three different advertisements, it is possible to compare the impact of showing only one advertisement at a time with showing two or three advertisements to the members. This allows advertisers to utilize their advertising resources most effectively.

### System Architecture

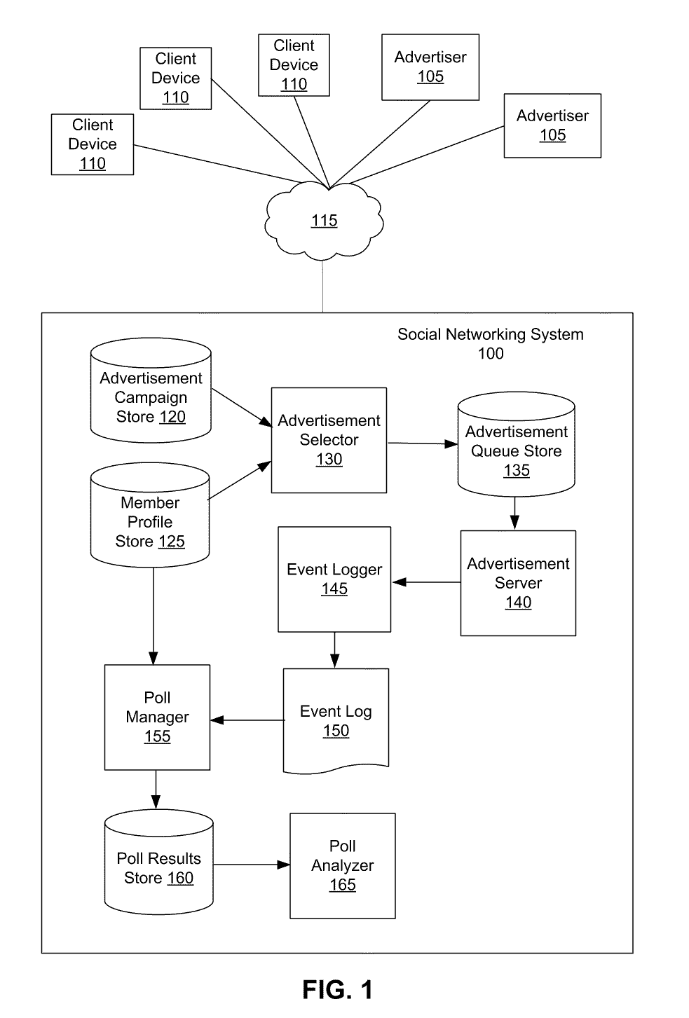

FIG. 1 is a high level block diagram illustrating a system environment that allows measurement of impact of an advertising campaign. The system environment comprises one or more client devices 110, a network 115, and an online system 100 that is configured to allow measurement of impact of advertisements in accordance with an embodiment of the invention. In alternative configurations, different and/or additional modules can be included in the system. In one embodiment, the online system 100 is a social networking system; in another embodiment, the online system 100 is an e-commerce system.

The client devices 110 comprise one or more computing devices that can receive member input and can transmit and receive data via the network 115. The client device 110 can be used by a member of the system 100 to interact with the system 100 to utilize a functionality provided by system 100. The client device 110 can also be used by an advertiser for defining an advertising campaign and providing attributes of the advertising campaign to the system 100. Examples of client devices 110 include desktop computers, laptop computers, smart phones, personal digital assistants (PDAs), or any other device including computing functionality and data communication capabilities. The client devices 110 are configured to communicate via network 115, including but not limited to, networks comprising any combination of local area and/or wide area networks, using both wired and wireless communication systems.

FIG. 1 shows component modules used by system 100. In this description, the term “module” refers to computational logic for providing the specified functionality. A module is implemented in a combination of hardware and software. It will be understood that the named modules described herein represent one embodiment of the present invention, and other embodiments may include other modules. In addition, other embodiments may lack modules described herein and/or distribute the described functionality among the modules in a different manner. Additionally, the functionalities attributed to more than one module can be incorporated into a single module. The software aspects of a module can be implemented as a standalone program that controls the hardware elements, but can also be implemented through other means, for example as part of a larger program, as a plurality of separate programs, or as one or more statically or dynamically linked libraries. The software aspects of the modules are stored on a computer readable storage medium (e.g., hard disk), loaded into the memory (also a computer readable storage medium), and executed by one or more processors included as part of the system 100 and thereby control the hardware aspects to perform the functions and steps described herein. System 100 further uses various “stores,” which are databases operating on computer readable storage mediums; such stores include both the underlying hardware components and the associated database management systems. As will become apparent, the various data processing operations described herein are sufficiently complex and time consuming as to necessarily require the operation of a computer system such as the system 100 in order to practice the present invention.

The modules of the system 100 include an advertising campaign store 120, a member profile store 125, an advertisement selector 130, an advertisement queue store 135, an advertisement server 140, an event logger 145, an event log 150, a poll manager 155, a poll results store 160, and a poll analyzer 165. In other embodiments, the system 100 may include additional, fewer, or different modules for various applications. Conventional components such as network interfaces, security mechanisms, load balancers, failover servers, management and network operations consoles, and the like are not shown so as to not obscure the details of the system.

The advertising campaign store 120 stores structures with fields suitable for describing an advertising campaign. An advertising campaign structure stores information identifying an advertiser, an advertising campaign, a set of one or more advertisements, a set of one or more questions for measuring impact of the advertisements, and parameters for the number of members to be included in the sample, control and any additional sets, and the desired number of responses to the questions. Questions for measuring impact of an advertisement or advertising campaign are targeted to members of system 100. An example question for measuring impact of an advertisement inquires about the member's awareness of a product being advertised. The advertising campaign information identifies the scope of the campaign including the criteria for selecting members targeted for the advertisement. In one embodiment, the criteria for selecting members may be associated with specific advertisements associated with the campaign, thereby allowing different criteria for selecting different advertisements for the same campaign. An advertisement may be targeted towards members based on attributes of the member stored in the member's profile, such as the member's demographics, including gender, age, geographical region, stated interests or preferences, professional, personal, or educational affiliations, or income. Affiliations include memberships in groups, lists, networks, forums, clubs within the online system, such as memberships within a particular network within a social network. For example, an advertisement may be targeted towards women younger than 30 years of age, who live in the San Francisco Bay area, are graduates from a list of specific colleges and universities, are members of a group of users of the online system. The criteria can also specify attributes regarding the member's behavior within or outside of the online system (or a combination of both), such as frequency of use of the system, length of time on the system, and access or use of specific features of the system or destinations outside the system. For example, an advertisement may be targeted to members who used the system at least five times a week for the past month and who have used a gift giving application within the last three days. The targeting criteria can comprise any data available to the online system and can be combined in any manner.

An advertisement can be associated with parameters that may determine effectiveness of an ad campaign, for example, (a) a time interval during which advertisements associated with the advertising campaign are shown to the members, (b) the order in which advertisements are shown, or (c) locations of advertisements if the campaign allows or requires different advertisements to be shown in different locations. Variations in an advertising campaign can be studied by analyzing the effect of varying the parameters associated with the advertisements that make up the campaign. For example, an optimal duration of presentation of an advertisement to a member can be studied for the ad campaign.

The member profile store 125 stores profiles of members. User accounts within the system 100 allow members to login to the system to use specific functionality provided by the system 100. A member may establish a profile that contains demographic and other information associated with the member, for example, gender, age, geographical location, education or professional affiliations, group memberships, interests, activities, income, nationality, race, and the like.

Any member may be selected to be a participant in the analysis of the effectiveness of one or more advertising campaigns. The advertisement selector 130 determines the advertisements that are to be shown to each member. An advertisement may be associated with a member according to criteria specified by an advertising campaign and/or the online system. The advertisements selected for a member are stored in the advertisement queue store 135. The advertisement queue store 135 stores structures that map members to advertisements associated with each member. Generally, each member is associated with a unique advertisement queue. Each advertisement can be further mapped to one or more advertising campaigns stored in the advertising campaign store 120. In one embodiment, the structures representing the mapping comprise a queue structure corresponding to each member such that the elements of the queue are advertisements to be shown to the member.

The advertisement server 140 processes the advertisement queue associated with a given member and determines whether an advertisement in the queue is to be shown to the member at a particular time (thereby including the member in the sample set, also referred to as the experimental set) or withheld from being shown to the member (thereby including the member in the control set). Withholding the advertisement from a control set of members allows comparison of members that are shown the advertisement with members that are not shown the advertisement. If the advertisement server 140 determines to show an advertisement to a member, the advertisement is configured for display and sent to the client device 110 associated with the member. In sum, where the advertisement selector 130 determines which members satisfy the campaign criteria for an advertising campaign, thus qualifying the member to view the advertisement—the advertisement server 140 determines whether a given member is in the sample set and will actually be presented with the advertisement or is in the control set and will not be presented with the advertisement.

In general, the advertisement server 140 can generate multiple experimental sets by varying certain characteristics of the advertisements shown to the members. Generally, the sample sets for a campaign can vary based upon the selection of the advertisements to be presented to the members in sample set, the order of presentation, and the manner of presentation (e.g., location on page, size, etc.) or any other technique or variation. For example, one control set can be generated that is not shown any advertisements from the ad campaign, an first sample set can be exposed to a three specific advertisements A, B, C, a second sample set can be shown only advertisements A and C, and a third set can be shown the advertisements in the reverse order C, B, A. Other experimental sets can be generated by varying other characteristics of the advertisement, for example, location of the advertisement within the web page displayed on the browser or any user interface used for showing the advertisement or the duration for which the advertisement is presented to the member. The control set and the experimental sets are kept independent of each other. Comparisons based on questions or polls used for evaluating the impact of the advertisement versions can be used for either comparing impact of a version of the advertisement with the control set or comparison of the impact of two different versions of the advertisement.

The actions of the advertisement server 140 are logged by the event logger 145 to event log 150. For example, each time an advertisement is shown to a member, the corresponding event is logged by the event logger 145 in the event log 150. Similarly, if an advertisement is withheld from the member by the advertisement server 140, the event is logged by the event logger 145 in the event log 150. Any variations in a campaign for additional sets of users are also logged by the event logger 145. The event logger may also log various other events occurring in the system 100, for example, messages received from members requesting information, members logging in to the system 100 or logging out from the system 100, members updating their profile, or similar events that are considered significant for purposes of logging. If the advertisement server 140 presents an advertisement based on particular characteristics, the event logger logs the characteristics being tested when an advertisement is presented. The event log 150 stores the information logged using structures that allow batch processing of the information. The batch processing of the event logs may be performed periodically at an interval that accumulates sufficient number of logs useful for processing. A log may store information that allows identification of the member associated with the event and if relevant, identification of an advertisement or advertising campaign associated with the event. This information allows a post processor to derive the set membership of the member ID and the experimental set that the member ID is associated with at a later stage if necessary.

The poll manager 155 processes events associated with showing of advertisements to members, withholding advertisements from members, and various other events performed for a particular set of members. The poll manager 155 also identifies what actions were taken for each set of members. The poll manager uses the above information to determine sets of members to whom questions associated with an advertising campaign are sent. The questions sent to the members by the poll manager may inquire about the impact of the advertisement by measuring the awareness of specific products advertised by the advertising campaign. If a member provides answers to the questions, the poll manager stores the results in poll results store 160. The information stored in the poll results store 160 includes information to identify the question presented to a member, the answer provided by the member, information to identify the member, identification of an associated advertising campaign and/or relevant portions thereof. The structures of the poll results store 160 allow analysis of the poll results, for example, statistical analysis to compute metrics associated with the poll results. The poll analyzer analyzes the poll results collected by the poll manager in order to quantify the impact of the advertising campaign (or portions, techniques and/or features thereof). The analysis of the polls is configured for display to the client device 110 and can be viewed either by the members of the system 100 or by an advertiser.

In some embodiments, the various modules shown as part of system 100 in FIG. 1 may be available as parts of different systems that are running on separate computers that communicate with each other for exchanging information. For example, the poll manager 155, poll results store 160, and the poll analyzer 165 may be executed on a computer maintained by a third party that specializes in conducting and analyzing polls whereas the remaining modules are executed by a website that shows the advertisements. In one embodiment, the member profile store is available in a system that collects demographic and other kind of profile information associated with members, for example, a social network whereas the advertisement campaign store 120, the advertisement selector 130, the advertisement queue store 135, and the advertisement server 140 modules are executed on a website that manages and displays advertisements. In one embodiment, the members of the social network are also members of the website showing the advertisements or at least there is an overlap between the members of the two systems. In another embodiment, the advertisements are shown on a website that is different from system 100 that executes the modules displayed in FIG. 1. The website showing the advertisements may send a message to the system 100 providing information identifying a member that is currently logged in to the website and the system 100 responds with information identifying one or more advertisements to be shown to the member.

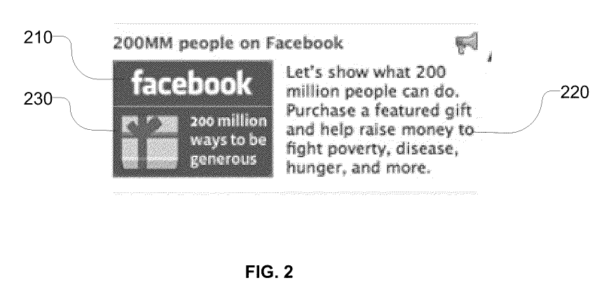

FIG. 2 shows an example of an advertisement presented to a member within the context of the online system 100. By assumption, the member has accessed the system 100, and is using one or more features, such as the member's account or home page, at which point the advertisement is shown. The advertisement may mention a brand name 210 that an advertiser is trying to promote. The advertisement may also display one or more images 230. Furthermore, the advertisement may display information in the form of text 220. The text 220 or the images 230 may contain hyperlinks to websites that provide further information related to the brand being advertised. The advertisement may also contain information associated with other members of the system related to the advertising campaign, such as member comments about the advertisement or the product/service that is the subject of the advertisement. The advertisement is placed in a user interface presented to the member, for example, a browser used for exploring the Internet. If the advertisement is withheld from the member, the space on the user interface that would have been occupied by the advertisement is used for some alternative purpose, for example, displaying information related to the system 100 or for presenting a different advertisement that can be displayed to the member.

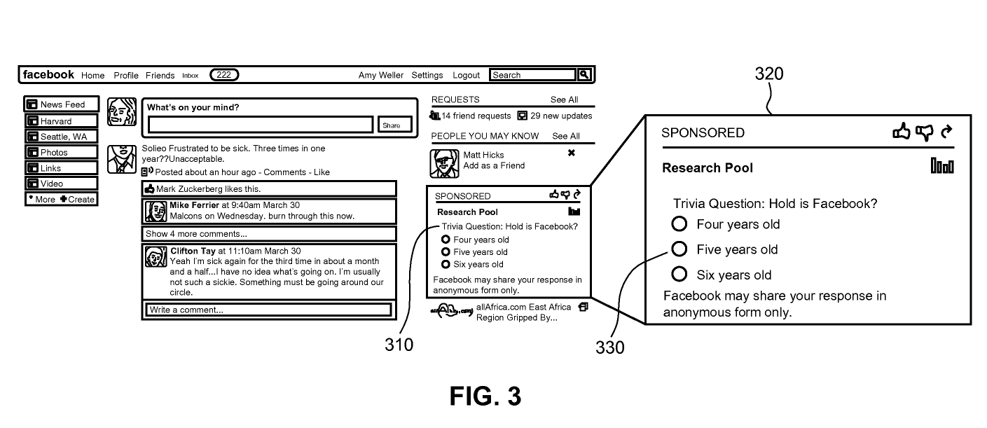

FIG. 3 is an illustration of a graphical user interface presenting a poll question 310 to a member. The portion of the user interface presenting the poll question 310 is enlarged to better show the details 320 of the question. The poll question 310 obtains feedback regarding any aspect of the advertising campaign the advertiser is interested in including, for example, awareness of the member of the product/service being advertised. For example, the question 310 asks about the member's awareness of the age of a specific website. If an advertisement displaying the age of the website was seen by the member multiple times, the chances of the member knowing a correct answer to the question 310 are high. If the advertisement displaying the age of the website was withheld from the member, the member is less likely to know the correct answer. The possible answers to the poll question 310 are presented as a radio button 330 allowing the member to select one of the answers. Other embodiments can allow the member to select an answer using a drop down list or input the answer using a text box.

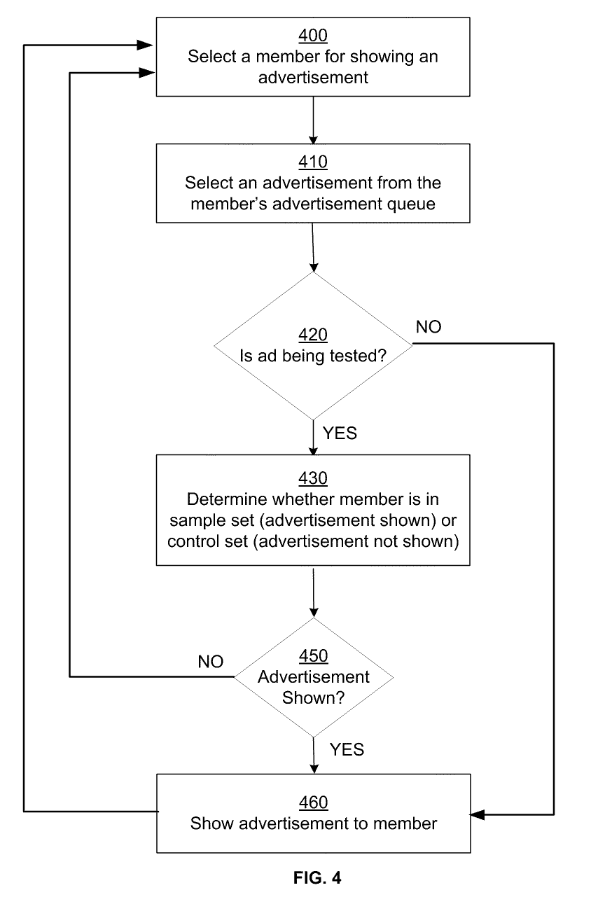

FIG. 4 shows a flowchart of the overall process for determining whether an advertisement is shown to a member or withheld from the member. The advertisement selector 130 computes the advertisement that needs to be displayed for each member and stores them in the advertisement queue store 135. As an initial condition, the member has already accessed the system 100, and is using a feature or portion of the system, such as the member's home page, wherein an advertisement is to be placed. At any given time there will be multiple different members for whom an advertisement needs to be selected. Accordingly, the advertisement server 140 selects 400 a member and further selects an advertisement from the member's advertisement queue. The advertisement server 140 checks 420 the information of the advertisement in the advertising campaign store 120 to determine if the advertisement is being tested for measuring its impact on the member awareness. If the advertisement is not being tested, the advertisement is shown 460 to the member; in other words, advertisements that are not being evaluated are shown to all members who satisfy the associated criteria.

If the advertisement is being tested, the advertisement server 140 makes a determination 430 whether the member is in the control set so that the advertisement should be withheld from the member, or in the sample set so that the advertisement is shown the member. In this embodiment, the advertisement server 140 computes a hash value based on the member ID or other information that can identify a member and the advertisement campaign ID. The output of the hash function is used to determine 450 whether the advertisement should be withheld from the member or displayed 460 to the member. The hash function can be computed either beforehand for the member and stored in the member's profile, or it can be computed each time an advertisement is to be presented to the member. This same process can be applied to additional sets of users who receive different variations of a particular campaign,

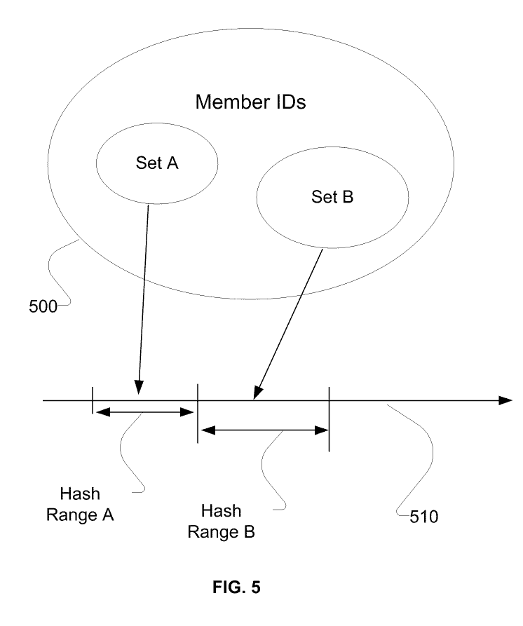

FIG. 5 illustrates how a hash function can be used to determine if a member ID belongs to a particular set of member IDs. The set 500 is the overall set of all member IDs stored in the member profile store 125 in the system 100; for example set 500 can contain 1,000,000 member IDs. A hash function is used to map a member ID and the advertisement campaign ID to a numeric value within a range, represented by the axis 510, to create a hash value for each member ID. All member IDs belonging to the set A (e.g., the sample set) associated with the ad campaign map to a range of values along axis 510 represented by range A. Similarly, all member IDs belonging to set B (e.g., control set) associated with the ad campaign map to a range of values along axis 510 represented by range B. Hence, given a member ID and the ad campaign ID the hash function output is computed. If the hash function output falls within range A, the member ID belongs to set A and if the hash function output falls within range B, the member ID belongs to set B. Similarly, other sets of member IDs can be mapped to other ranges of hash function output values, establishing further sets of members. One embodiment of a hash function uses the MD5 hashing algorithm combined with a modulo operator, for example, md5(x)% K where md5 is the MD5 hash function, x is the input to the MD5 hash function, and K is a predetermined constant. The extent of each range can be set by the advertiser or system administrator to control the number of members that fall within each range.

The sets of member IDs computed using the hash function as described in FIG. 5 can be used to compute sets of member IDs that can be used to study impacts of advertisements in various ways. For example, a set of member IDs can be mapped to a specific advertisements and members with member IDs belonging to the set shown only the specific advertisement. Alternatively, members belonging to a set can be shown more than one kind of advertisements to study impact of showing combinations of advertisements or other advertising techniques. A set of member IDs can be selected for withholding ads such that members with member IDs in the set do not see selected ads or an entire campaign.

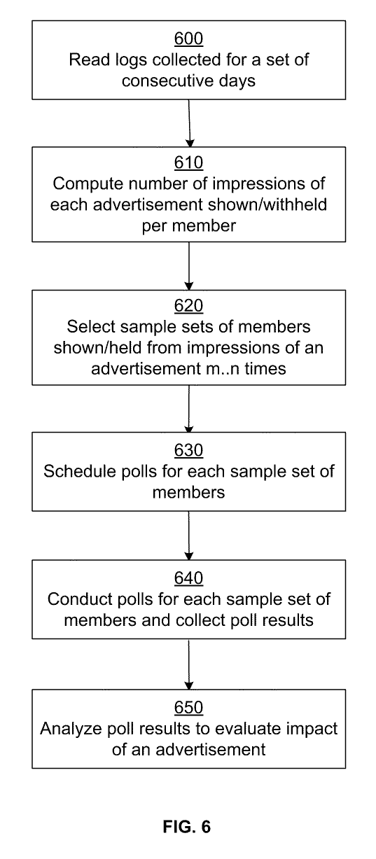

As shown in FIG. 1, the data related to the advertisement presentations and withholdings is collected in event log 150. FIG. 6 show a flowchart of the process for conducting polls for sample sets of members and analyzing the poll results to determine a measure of effectiveness of an advertising campaign in accordance with an embodiment of the invention. The poll manager 155 reads 600 logs collected in event logs 150 for a set of days, which may be consecutive or sampled. The poll manager 155 analyzes the logs to compute 610 the number of impressions of an advertisement either shown to each member in an experimental set or withheld from each member in a control set. The poll manager computes ranges of numbers m . . . n representing the number of impressions of an advertisement shown to a member and selects 620 sample sets of members corresponding to each range. For example, one test set of members may be shown/withheld from seeing 1-5 impressions and another test set of members may be shown/withheld from seeing 6-10 impressions. The test sets have a predetermined cardinality such that data collected for the test sets is statistically significant; for example the campaign criteria can specify that all least 100,000 members are to be included in the sample and control sets. The poll manager 155 schedules polls for members belonging to the test sets based on the ranges of impressions of advertisements and conducts 640 the polls for each test sets. For example a fixed number of polls may be conducted each day resulting in the polls being conducted over several days. Not everyone presented with a poll may respond to the poll. For example, 1-2% of members presented with polls may respond to the poll questions. Accordingly, if 500-1000 responses are desired from the polls, the number of members presented with the poll questions can be as high as 40,000-80,000. The number of responses obtained is measured and polls stopped when a predetermined number of responses are obtained. Another embodiment displays polls to a fixed number of members in each control and experimental set. The poll results collected are saved in the poll results store 160. The poll results stored in poll results store 160 are analyzed 650 by the poll analyzer 165 to determine the effectiveness of the advertisements.

Various statistical techniques may be used to compute a measure of effectiveness of an advertisement. For example, one measure of effectiveness is a lift metric. Lift is computed as the percentage change in awareness or favorability towards a product due to the advertisement. For example, assume that the favorability of members withheld from an advertisement is computed to be x1% and the favorability of members shown the advertisement is computed to be x2%, the lift value L is calculated as:

$$L = \frac{x 2 - x 1}{x 1} \times 100 \% \qquad ( 1 )$$

As shown above, the lift L provides a measure of improvement in favorability towards a product as a result of showing an advertisement to the members. Other kinds of statistical analysis can be performed, for example, statistical significance of responses obtained for a question can be computed using z-test.

A sample result obtained for an advertisement is shown in the following table:

| | Improvement in Product | |
|---|---|---|
| Number of Impressions | Awareness | Brand Favorability |
| 1-5 | a1 % | b1 % |
| 6-10 | a2 % | b2 % |

The column representing number of impressions presents different ranges of number of impressions presented to the member. In this case, the improvement in product awareness is measured based on a question “Are you aware of the product?” and measures the increase in product awareness by showing the corresponding number of impressions of the advertisement. Similarly, in this case, brand favorability is measured based on a question “How much do you like brand x?” and measures the increase in brand favorability as a result of showing the corresponding number of impressions of the advertisement. The numbers a1, a2, b1, and b2 are numeric values. The questions being evaluated are qualitative and potential answers are presented to the member to obtain a response that can be converted to a quantitative measure. For example, answers to a question measuring favorability towards a brand can be “very favorable,” “favorable,” “unfavorable,” and “very unfavorable.” The favorability towards the brand is inferred based on statistical significance of the lift for each possible answer for a given question.

In some embodiments, the measure of effectiveness of an advertisement can be adjusted or based on demographics of the test sets. This is possible in the online system where information regarding the demographics of the members is available. For example, the differences in the impact of the advertisement based on geographical regions of the members can be determined. Similarly, the differences in the impact of the advertisement based on age or gender of the members can be determined. The accuracy of such analysis depends on the accuracy of the demographics information available in member profile store 125 for the members of system 100.

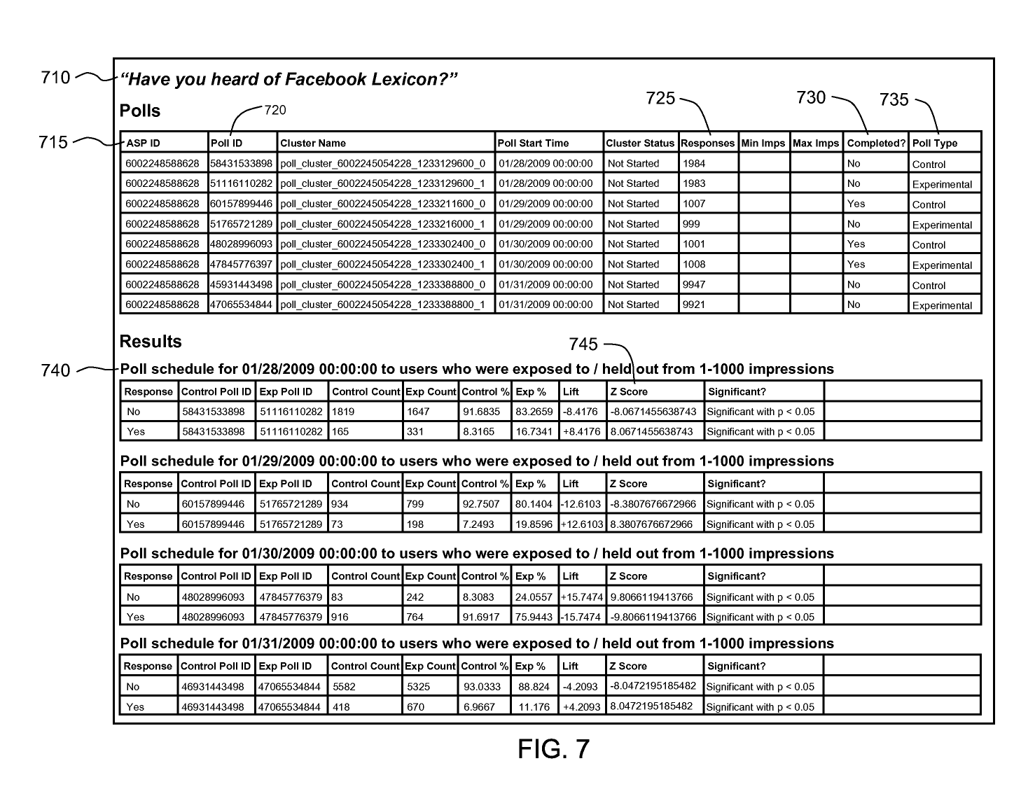

FIG. 7 illustrates an example of the results of measuring the effectiveness of an advertising campaign. Each poll is identified by an adverting campaign ID (“ASP ID”) 715, and a particular Poll ID 720. For each poll, the number of responses 725 is shown, an indication 730 of whether the poll is completed, and poll type 735 indicating whether the poll is for the control set of members or the sample set (here labeled “Experimental”) of members. The specific details for various polls are also shown. For example, the first poll results 740 are directed to members who were exposed/withheld from anywhere from 1 to 1000 impressions of an advertisement. The question 710 presented in the poll was “Have you heard of Facebook Lexicon?” The control set had 1819 “No” responses to this question and 165 “Yes” responses, while the experimental set had 1647 “No” responses” and 331 “Yes” responses. The lift within the “Yes” responses is 8.4176. Other statistical metrics associated with responses associated with each poll are shown, for example, the z-score 745 calculated using standard hypothesis testing techniques. If the z-score exceeds a certain threshold, it can be concluded that the advertisement created a statistically significant lift. This conclusion corresponds to rejecting the null hypothesis (that there was no effect of the advertisement on the members).

The ability to accurately measure the impact of advertisements in a highly controlled manner allows advertisers to systematically develop and improve their advertising campaigns. For example, advertisements with very little favorable impact on members can be eliminated and replaced with new advertisements. Combinations of advertisements with high impact can be promoted. Demographics based analysis may be used to promote specific advertisements for specific sets of members. The impact of number of impressions of an advertisement can be analyzed to determine if increase in number of impressions reaches a point of diminishing returns. Accordingly, the optimal number of impressions can be scheduled for presentation to the members, thereby optimizing the amount of money spent by an advertiser to achieve a desired level of advertising impact.

Some online systems include mechanisms to promote products and brand names outside of the paid advertisements from the advertisers. For example, a social networking system may provide information to members about products or services related to or generated by activities of other members. Social networking systems provide mechanisms like newsfeed that distribute information related to activities of one member to other members. A member may purchase a product as a result of seeing an online advertisement and this fact can be broadcast in a message to friends of the member who are also members of the social network system. Similarly, a member can comment on an online advertisement and the comments can be broadcast in a message to the member's friends using newsfeed or any other mechanism supported by the social network system. Members can discuss a particular product or an advertisement of the product on an online forum and the discussion made available to friends of the members on the social network system. Thus, a social network system generates content (herein “secondary content”) based on members' interactions with advertisements, products or services or interactions related to advertisements, products or services, and this secondary content in itself functions as a secondary level of brand promotion. As a result, the social network system has an impact on the effectiveness of the advertisement as well as favorability of the members towards the advertised products due to communication mechanisms implemented in the social network system. This effectiveness can be called network effectiveness, or secondary effectiveness.

Since the social networking or other online system controls the communication mechanisms that generate and distribute content based on advertisements, products or services, the social networking system can evaluate the impact of these communication mechanisms on the network effectiveness of an advertisement by creating a experimental set and a control set (as well as other experimental sets) from those members who are exposed to the secondary content. The members of a control set are withheld from seeing the secondary content and members of the experimental sets are presented with the secondary content. The advertisement itself is presented to members of both the control set and the experimental set. As a result, a poll conducted to evaluate the two sets provides a comparison of the impact of the communication mechanisms themselves on members' favorability or awareness of a product or brand. This effectively measures the ability of the social networking system to enhance the impact of an online advertisement as well as favorability or awareness of a product over and above the advertisement itself. Further, an advertiser can determine the effectiveness of a paid advertisement campaign versus the effectiveness of the secondary content (or combinations of both) resulting from such paid advertisements.

The ability to measure the impact of features available in a social network system on the effectiveness of an advertisement is beneficial to advertisers and consumers because it provides an ability to experiment with different strategies so as to improve the generation, distribution and relevance of content generated based on online advertisements. Besides, online advertisements provide a source of income to social networking systems and social networking systems that can demonstrate more effective tools and metrics for effective online advertising can attract more advertising revenue compared to other websites and advertising outlets.

### Alternative Applications

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer implemented method of evaluating effectiveness of an online advertising campaign comprising advertisements, wherein the advertising campaign is presented to a set of members of an online system, the method comprising:
associating each member from the set of members with one or more advertisements that can be displayed to the member;
responsive to detecting a member accessing the online system:
selecting an advertisement associated with the member;
determining whether the member belongs to a sample set of members or a control set of members;
responsive to the member belonging to the control set, withholding the advertisement from presentation to the member;
responsive to the member belonging to the sample set, providing the advertisement for presentation to the member; and
determining a measure of effectiveness of the advertising campaign based on information received from members from the control set and from members from the sample set.

2. The method of claim 1, wherein determining a measure of effectiveness of the advertising campaign comprises:
providing a question to a member belonging to one of the sample set or the control set of members, while the member is accessing the online system; and
receiving a response from the member including an answer to the question, wherein the answer is indicative of effectiveness of the advertisement.

3. The method of claim 2, wherein answers to the question are indicative of awareness of the subject of the advertisement.

4. The method of claim 2, wherein answers to the question are indicative of favorability towards the subject of the advertisement.

5. The method of claim 1, wherein determining whether the member belongs to a sample set of members or a control set of member comprises computing a hash value based on at least a member ID associated with the member.

6. The method of claim 1, wherein an advertisement is withheld from a member of the control set a predetermined number of times within a predetermined time interval, and the advertisement is presented to members belonging to one of the sample set or the control set of members the predetermined number of times within the predetermined time interval.

7. The method of claim 1, wherein the set of members is determined based on attributes of members.

8. The method of claim 1, wherein the set of members is determined based on demographics of members.

9. The method of claim 1, wherein the set of members is determined based on interests of members.

10. The method of claim 1, wherein the set of members is determined based upon affiliations of the members.

11. The method of claim 1, wherein the set of members is determined based upon activities of the members within the online system.

12. The method of claim 1, wherein determining a measure of effectiveness of the advertising campaign comprises computing a lift in favorability of members towards the subject of the advertisement.

13. The method of claim 1, wherein a member has an account for which the member has registered, and a profile storing attributes of the member, the attributes including demographic information of the member.

14. The method of claim 1, wherein a member is associated with a profile storing the attributes of the member, the attributes including historical information of the member's activities within the online system.

15. A computer-implemented system for evaluating effectiveness of an online advertising campaign comprising advertisements, wherein the advertising campaign is presented to a set of members of an online system, the system comprising:
a computer processor; and
a computer-readable storage medium storing computer program modules configured to execute on the computer processor, the computer program modules comprising:
an advertisement selector module configured to:
associate each member from the set of members with a one or more advertisements that can be displayed to the member;
an advertisement server module configured to:
select an advertisement associated with the member;
determine whether the member belongs to a sample set of members or a control set of members;
withhold the advertisement from presentation to the member, responsive to the member belonging to the control set;
provide the advertisement for presentation to the member, responsive to the member belonging to the sample set; and
a poll analyzer module configured to:
determine a measure of effectiveness of the advertising campaign based on information received from members from the control set and from members from the sample set.

16. The system of claim 15, wherein determining a measure of effectiveness of the advertising campaign comprises:
providing a question to a member belonging to one of the sample set or the control set of members, while the member is accessing the online system; and
receiving a response from the member including an answer to the question, wherein the answer is indicative of effectiveness of the advertisement.

17. The system of claim 16, wherein answers to the question are indicative of awareness of the subject of the advertisement.

18. The system of claim 16, wherein answers to the question are indicative of favorability towards the subject of the advertisement.

19. The system of claim 15, wherein determining whether the member belongs to a sample set of members or a control set of member comprises computing a hash value based on at least a member ID associated with the member.

20. The system of claim 15, wherein the set of members is determined based on demographics of members.

21. The system of claim 15, wherein the set of members is determined based on attributes of members.

22. The system of claim 15, wherein the set of members is determined based on interests of members.

23. The system of claim 15, wherein the set of members is determined based upon affiliations of the members.

24. The system of claim 15, wherein the set of members is determined based upon activities of the members within the online system.

25. The system of claim 15, wherein determining a measure of effectiveness of the advertising campaign comprises computing a lift in favorability of members towards the subject of the advertisement.

26. The system of claim 15, wherein a member has an account for which the member has registered, and a profile storing attributes of the member, the attributes including demographic information of the member.

27. The system of claim 15, wherein a member is associated with a profile storing the attributes of the member, the attributes including historical information of the member's activities within the online system.

28. A computer implemented method of evaluating effectiveness of an online advertising campaign comprising advertisements, wherein the advertising campaign is presented to a set of members of a website, the method comprising:
associating each member from the set of members with one or more advertisements that can be displayed to the member;
receiving a request for determining an advertisement to be presented to a member interacting with the website;
selecting an advertisement associated with the member;
determining whether the member belongs to a sample set of members or a control set of members;
responsive to the member belonging to the control set, withholding the advertisement from presentation to the member;
responsive to the member belonging to the sample set, responding to the request with the advertisement; and
determining a measure of effectiveness of the advertising campaign based on information received from members from the control set and from members from the sample set.

29. A computer implemented method of evaluating effectiveness of an online advertising campaign comprising advertisements, wherein the advertising campaign is presented to a set of members of an online system, the method comprising:
determining a first set of advertisements belonging to the advertising campaign and a second set of advertisements belonging to the advertising campaign;
associating each member from the set of members with one or more advertisements belonging to the advertising campaign that can be displayed to the member;
responsive to detecting a member accessing the online system:
selecting an advertisement associated with the member;
determining whether the member belongs to one of a first experimental set of members, a second experimental set of members, or a control set of members;
responsive to the member belonging to the first experimental set of members, presenting an advertisement from the first set of advertisements to the member;
responsive to the member belonging to the second experimental set of members, presenting an advertisement from the second set of advertisements to the member;
responsive to the member belonging to the control set, withholding the advertisement from presentation to the member; and
determining a measure of effectiveness of the advertising campaign based on information received from members belonging to the first experimental set of members, the second experimental set of members, and/or the control set of members.

30. A computer implemented method of evaluating effectiveness of an online advertising campaign comprising advertisements, wherein the advertising campaign is presented to a set of members of an online system, the method comprising:
determining a parameter associated with presentation of an advertisement of the advertising campaign and a first parameter value and a second parameter value of the parameter;
associating each member from the set of members with one or more advertisements that can be displayed to the member;
responsive to detecting a member account accessing the online system:
selecting an advertisement associated with the member;
determining whether the member belongs to one of a first experimental set of members, a second experimental set of members, or a control set of members;
responsive to the member belonging to the first experimental set of members, presenting the advertisement to the member based on the first parameter value;
responsive to the member belonging to the second experimental set of members, presenting the advertisement to the member based on the second parameter value;
responsive to the member belonging to the control set, withholding the advertisement from presentation to the member; and
determining a measure of effectiveness of the advertisement campaign based on information received from members belonging to the first experimental set of members, the second experimental set of members, and/or the control set of members.

31. The method of claim 30, wherein a parameter determines the time duration during which the advertisement is shown to members.

32. The method of claim 30, wherein a parameter determines an order in which different advertisements are presented to the member.

33. The method of claim 30, wherein a parameter determines the location of the advertisement in a user interface used for showing the advertisement.

34. The method of claim 30, wherein a parameter determines whether comments provided by members for the advertisement are presented with the advertisement.

35. The method of claim 30, wherein a parameter determines whether content generated by members related to the advertisement is presented with the advertisement.

36. The method of claim 30, wherein determining a measure of effectiveness of the advertising campaign comprises:
providing a question to a member belonging to one of the sample set or the control set of members, while the member is accessing the online system; and
receiving a response from the member including an answer to the question, wherein the answer is indicative of effectiveness of the advertisement.

37. The method of claim 36, wherein answers to the question are indicative of awareness of the subject of the advertisement.

38. The method of claim 36, wherein answers to the question are indicative of favorability towards the subject of the advertisement.

39. The method of claim 30, wherein determining whether the member belongs to one of a first experimental set of members, a second experimental set of members, or a control set of members comprises computing a hash value based on at least a member ID associated with the member.

40. The method of claim 30, wherein the set of members is determined based on attributes of members.

41. The method of claim 30, wherein the set of members is determined based on demographics of members.

42. The method of claim 30, wherein the set of members is determined based on interests of members.

43. The method of claim 30, wherein determining a measure of effectiveness of the advertising campaign comprises computing a lift in favorability of members towards the subject of the advertisement.

44. The method of claim 30, wherein the set of members is determined based upon affiliations of the members.

45. The method of claim 30, wherein the set of members is determined based upon activities of the members within the online system.

46. The method of claim 30, wherein determining a measure of effectiveness of the advertising campaign comprises computing a lift in favorability of members towards the subject of the advertisement.

47. The method of claim 30, wherein a member has an account for which the member has registered, and a profile storing attributes of the member, the attributes including demographic information of the member.

48. The method of claim 30, wherein a member is associated with a profile storing the attributes of the member, the attributes including historical information of the member's activities within the online system.
